(19) United States
(12) Patent Application Publication
(10) Pub. No.: US 2011/0210014 A1
(43) Pub. Date: Sep. 1, 2011

(54) CORROSION SENSOR SYSTEM

(76) Inventor: Thomas J. Garosshen, Glastonbury, CT (US)

(21) Appl. No.: 13/127,268

(22) PCT Filed: Nov. 3, 2008
(86) PCT No.: PCT/US2008/082197

§ 371 Date: May 3, 2011

(51) Int. Cl. G01N 17/04; G01N 17/02

(52) U.S. Cl. 205/776.5; 204/404; 205/775.5

(57) ABSTRACT

A corrosion sensor system includes a substrate with a hydrophilic coating and a sensor array attached to the substrate, the sensor array manufactured of a noble metal. The sensor system operates to determine a time of wetness measurement based upon an electrolyte conductivity and a temperature.

### BACKGROUND

The present application relates to vehicle maintenance systems and, more particularly, to data acquisition related to vehicle corrosion.

Significant material and maintenance costs on military as well as commercial aircraft are often attributed to the severity of the environment in which the aircraft operate. Rotary-wing aircraft which operate in a maritime environment may be particularly susceptible to corrosion.

Under the influence of corrosion, corrosion damage of aircraft structural materials such as steel and aluminum may reduce aircraft useful life. Even non-metallic materials such as graphite/epoxy composites are susceptible to such effects.

Many aircraft owners have mandated a switch from calendar-based to condition-based maintenance to reduce aircraft ownership costs. This will eliminate unnecessary inspections and also detect maintenance issues before any particular issue becomes significant. Current corrosion sensor systems may not facilitate condition-based maintenance as current sensors may be of limited durability, may not correlate well to actual corrosion conditions, and may not detect specific types of corrosion damage typical to aircraft environments.

Robust sensor technologies will be required to achieve the condition based maintenance goals for the primary aircraft damage modes—fatigue and corrosion.

### SUMMARY

A corrosion sensor system according to an exemplary aspect of the present invention includes a substrate with a hydrophilic coating and a sensor array attached to the substrate, the sensor array manufactured of a noble metal.

A method of corrosion detection according to an exemplary aspect of the present invention includes determining a time of wetness measurement based upon an electrolyte conductivity, ionic strength of electrolyte, and a temperature.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a general perspective view of an exemplary rotary wing aircraft embodiment for use with the present invention;

FIG. 2A is a block diagram of a corrosion sensor system;

FIG. 2B is a schematic view of a corrosion sensor system with a corrosion sensor below a coating;

FIG. 3A is a top view of a sensor array attached to a substrate;

FIG. 3B is a side view of a sensor array attached to a side of the substrate of FIG. 3A;

FIG. 4 is a graphical representation of the effect of excitation frequency on measurement for the sensor array;

FIG. 5 is a plot of the measured output from the corrosion sensor vs. salt level;

FIG. 6 is a plot which illustrates that the corrosion sensor will effectively track a one hour wet/dry corrosion chamber cycle;

FIG. 7 is a plot which illustrates that the corrosion sensor correlates to actual corrosion damage; and

FIG. 8 is a plot of the measured output from the corrosion sensor vs. relative humidity level.

### DETAILED DESCRIPTION

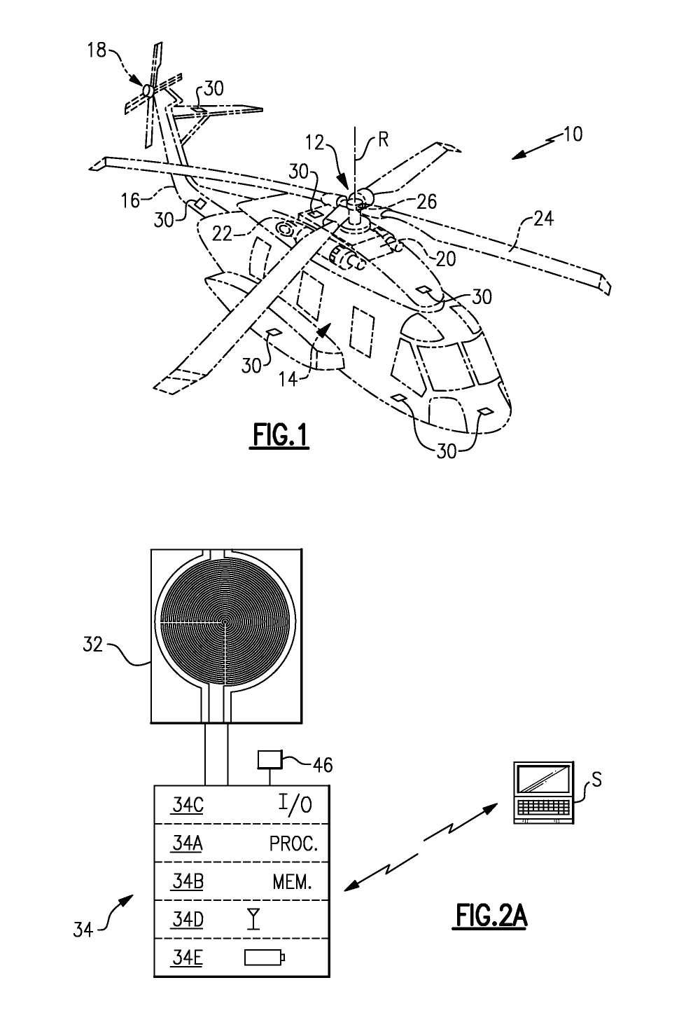

FIG. 1 schematically illustrates an exemplary vertical takeoff and landing (VTOL) rotary-wing aircraft 10. The aircraft 10 in the disclosed, non-limiting embodiment includes a main rotor system 12 supported by an airframe 14 having an extending tail 16 which mounts a tail rotor system 18, such as an anti-torque system. The main rotor assembly 12 is driven through a main gearbox (illustrated schematically at 20) by one or more engines 22. The main rotor system 12 includes a multiple of rotor blades 24 mounted to a rotor hub 26. Although a particular helicopter configuration is illustrated and described in the disclosed embodiment, other land, sea, and air vehicles, as well as fixed structures will also benefit from the disclosure.

A multitude of corrosion sensor systems 30 are applied to the airframe 14. In one example, the corrosion sensor systems 30 are applied to areas on the airframe 14 where corrosion or other damage may be likely to occur. These areas are often referred to as “hot spots,” which may be areas prone to corrosion or water trap. The corrosion sensor systems 30 may be applied throughout the airframe 14 inclusive of non-readily accessible areas such as below the cabin and cockpit floor. The corrosion sensor systems 30 may also be configured to form a sensor network.

Referring to Figure 2A, each corrosion sensor system 30 includes a corrosion sensor 32 and a data log unit 34. The data log unit 34 generally includes a processor 34A, a memory 34B, an interface 34C, a wireless communication system 34D, and a power supply 34E. The corrosion sensor 32 communicates with the data log unit 34 through the interface 34C such that data from the corrosion sensor 32 is stored in the memory 34B.

The data log unit 34 wirelessly communicates with an external system S such as a laptop or hand held computer through the wireless communication system 34D to download data stored within the memory 34B.

Referring to FIG. 2B, the corrosion sensor 32, in one non-limiting embodiment, may include pin connectors 36 which extend therefrom. The hermetric pin connectors facilitate attachment of the corrosion sensor 32 to a substrate such as the airframe 14 and below a coating P such as a paint layer. The pin connectors 36 extend through the coating P. The data log unit 34 is attached over the coating P and communicates with the corrosion sensor 32 through the pin connectors 36 which extend therethrough. The corrosion sensor 32 is thereby located in a position to, for example, identify corrosion while the data log unit 34 is positioned to facilitate communication through the wireless communication system 34D (FIG. 2A). The data log unit 34 is also readily replaceable without disturbance to the corrosion sensor 32 below the coating P.

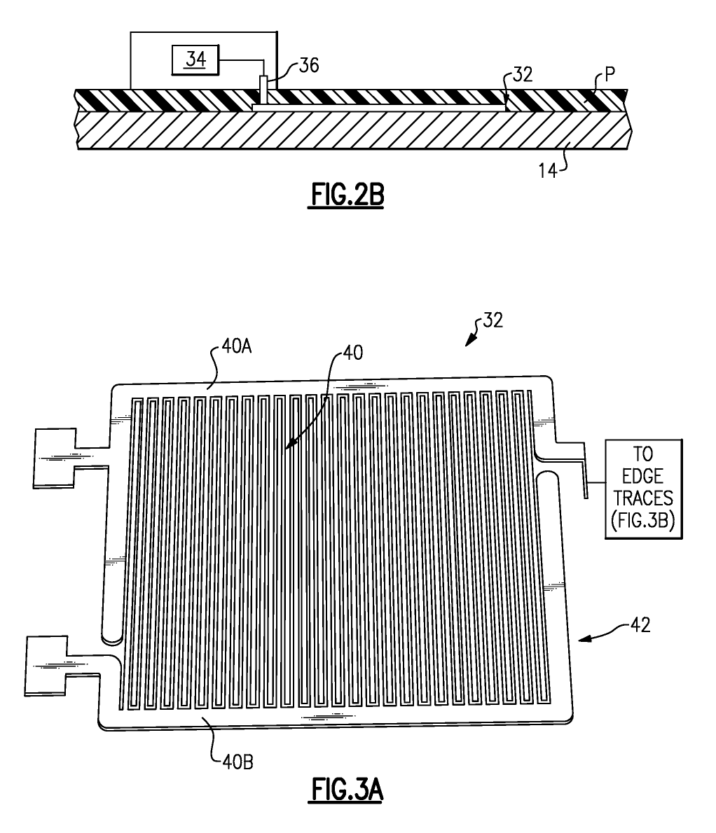

Referring to FIG. 3A, the corrosion sensor 32 generally includes a sensor array 40 attached to a substrate 42. The sensor array 40 includes at least two interlaced inert electrodes 40A, 40B. The inert electrodes 40A, 40B of the sensor array 40 may be manufactured of a noble metal such as Au, Pt, & Pd because of the low contact resistances provided thereby, and because noble metals are essentially inert as defined herein such that the sensor array 40 will not readily corrode in typical environments. Alternatively, the sensor array 40 may be manufactured of a conductive polymer material.

The sensor array 40 may further include side inert electrodes 40C, 40D attached to an edge 44 of the substrate 42 to detect filiform type corrosion and blistering (FIG. 3B). Filiform corrosion is a linear corrosion blister that initiates at a defect in the coating such as the paint layer P and propagates under the coating. Filiform corrosion often moves in a straight line until affected by an obstacle such as the corrosion sensor 32 located under the coating P. The presence of damage to the coating P is a significant issue for prediction of corrosion damage as for most aircraft corrosion issues, the coating P has to be damaged for corrosion to occur.

The substrate 42 may be manufactured of a polyimide material such as Kapton or other polymer with high resistivity which may be further treated with a hydrophilic coating such as Anionic surfactant or fatty acid soap material. Alternatively, the substrate 42 is plasma treated to modify the polyimide surface to change the chemical nature thereof to provide the hydrophilic coating. The hydrophilic coating may be located within and between the inert electrodes 40A-40D. Hydrophilic coatings or materials become wet very easily, and maintain the wetness for a relatively long time period. The substrate 42 is thereby treated to be highly attractive to water so the water molecules will push away other molecules in order to gain access to the corrosion sensor 32. Once formed, hydrogen bonds are quite stable and reluctant to break apart which rejects contaminants from the corrosion sensor 32 such that the corrosion sensor 32 remains clean and functional for a prolonged time period. The substrate 42 will not be readily fouled with oil, grease, hydraulic fluid, fuel or other hydrophobic substances typical of an aircraft environment.

The corrosion sensor 32 operates to detect general corrosivity of environment and corrosion damage modes which may include filiform corrosion, exfoliation corrosion, and coating deterioration. More specifically, the corrosion sensor 32 operates to detect relative humidity which indicates the generic weather environment within which the aircraft 10 operates and discrete liquid contact such as, for example trapped fluids, seawater, fluid spills, etc. The corrosion sensor 32 further operates irrespective of corrosion protection compounds which are often utilized to wash maritime aircraft as the corrosion sensor 32 is manufactured of inert compounds and does not readily corrode.

The corrosion sensor system 30 detects weather humidity conditions as well as also measure time and temperature to facilitate collection of variables which facilitate determination of corrosion in aircraft—time of wetness, electrolyte strength and temperature. Temperature may be measured through a thermister device 46 (FIG. 2A) which communicates with the data log unit 34. It should be understood that alternative or additional data may also be measured and stored in memory 34B to provide other functionality. In one non-limiting embodiment, temperature and conductivity versus time is stored in memory 34B such that the area under of the conductivity vs. time curve is related to corrosion rate by an empirical equation derived from testing.

Since corrosion is primarily controlled by the concentration of an electrolyte, the time of wetness and the temperature, the corrosion sensor 32 may be used to measure the concentration of an electrolyte and the time of wetness yet is constructed of materials resistant to corrosion.

The specific conductivity relates to the electrical conductivity determined by the sensor array 40A constant related to the geometry of the sensor array 40 facilitates conversion of the measured conductivity into the specific conductivity. The specific conductivity (L) of an electrolyte containing A and B ions is proportional to the equivalent concentrations of the dissolved ions as shown by the following equation:

$$L = \frac{α cF}{1000} ( {U}_{A +} + {U}_{B -} )$$

where:
α is the fractional ionization;
c is the solute concentration;
U is the true respective ionic mobility; and
F is the Faraday constant.

Conductivity measurements provide a measure of the concentration of an electrolyte. This also provides a time of wetness (TOW) measurement based upon the relative level of conductivity.

Corrosion Rate=ƒ(C, t, T)

where:
C is concentration (electrolyte strength)
t is time of wetness
T is temperature

The measured conductivity and a conversion factor may be utilized to provide concentration, (C) in the corrosion rate formula as the conductivity factors into the concentration of the electrolyte, the ion charge and the ionic mobility, all of which correlate to corrosivity. The time of wetness may be determined by the length of time above a particular humidity level, for example, 60%. The length of time above the particular humidity level is determined by the conductivity measurement. That is, humidity will have a relatively smaller conductivity signal then an actual puddle of water in contact with the sensor array 40. In one non limiting embodiment, the processor 34A in the data log unit 34 calculates the conductivity using, for example only, an ASIC (Application Specific Integrated Circuit) such Analog Devices #AD5933 manufactured by Analog Devices, Inc., of Norwood, Mass. USA.

A dry dielectric surface exhibits extremely low conductivity, while a dielectric surface covered by, for example seawater, exhibits a high conductivity. The combination of TOW and electrolyte conductivity provides an effective correlation to actual corrosion damage, but without the sensor element degradation associated with a conventional corrosion sensor that corrodes to create the output signal.

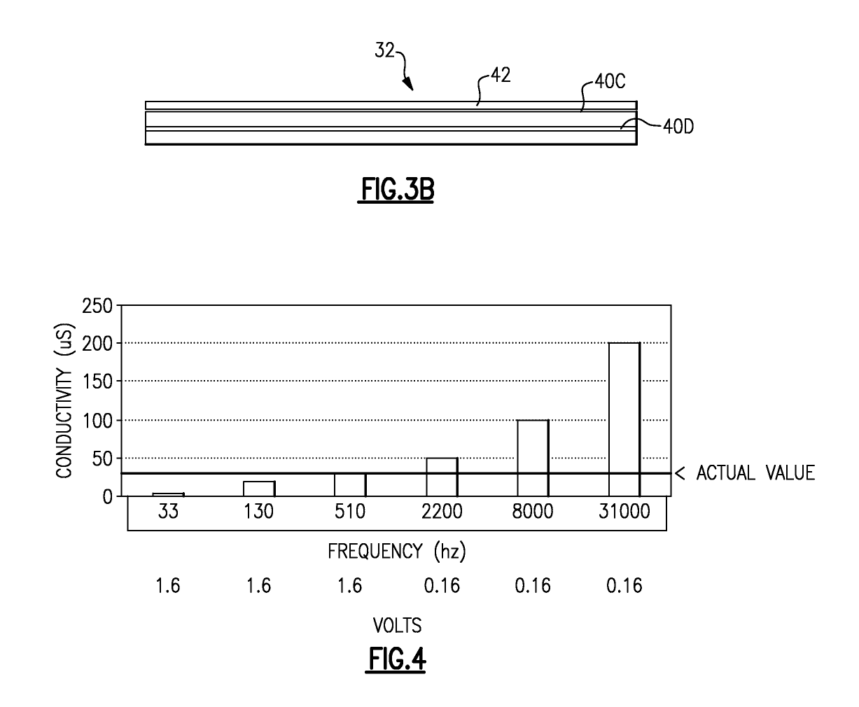

The corrosion sensor system 30 measures the electrolyte conductivity of a solution by the passage of an alternating current (AC) through any solution that may be between the two inert electrodes 40A, 40B and measurement of the voltage drop. Noble metal such as Au, Pt, & Pd electrodes have low contact resistances yet do not readily corrode to thereby avoid the consumption thereof. AC currents, with frequencies around 1000 Hz±900 Hz at several volts, may be utilized to prevent polarization of the electrolyte (FIG. 4). FIG. 4 illustrates the effect of frequency and the measurement accuracy is sensitive to excitation frequency and is related to the concentration of the electrolyte. Conductivity measurements are performed with the AC signal such that either the voltage or the current level is set and the other is utilized to calculate the conductivity which is the reciprocal of resistance. Alternately, other methods to measure conductivity may be utilized such as AC phase shifts.

For alloys and corrosive environments typical to aircraft applications, the corrosion output data from the corrosion sensor system 30 provides a significant correlation to actual corrosion damage.

In operation, the corrosion sensor system 30 measures time, temperature and electrolyte conductivity which is essentially the strength of the liquid electrolyte in contact with the corrosion sensor 32. The measurement of electrolyte conductivity is therefore a measure of the concentration and mobility of ions in the solution. Utilization of the concentration of the ionic species and the time of wetness (TOW) increases accuracy to model and predict corrosion rates. If an aggressive corrosive condition such as a spill is detected, the particular corrosion sensor system 30 provides an alert to the maintenance personnel through the external system S for direct correction.

In operation when the corrosion sensor 32 is below the coating, the conductivity of the coating P must be accounted for. Coatings such as paint are good dielectrics until compromised by the absorption of active fluids, mechanical damage or thermal damage. When damage occurs, either the predetermined coating conductivity will increase or the corrosion sensor 32 becomes exposed to a substance with higher conductivity than the coating such as water or the corrosion product within a filiform blister. Either way, the corrosion sensor system 30 will identify that the protective nature of the coating P has decreased and the underlying airframe 14 may be at risk.

Referring to FIG. 5, a plot of the measured output (e.g., calculated and measured by the data unit 34) from the corrosion sensor 32 versus salt level illustrates that the corrosion sensor system 30 is very sensitive to corrosive electrolyte strength. The corrosion sensor 32 is operable to measure electrolyte strengths from pure water to seawater salt levels.

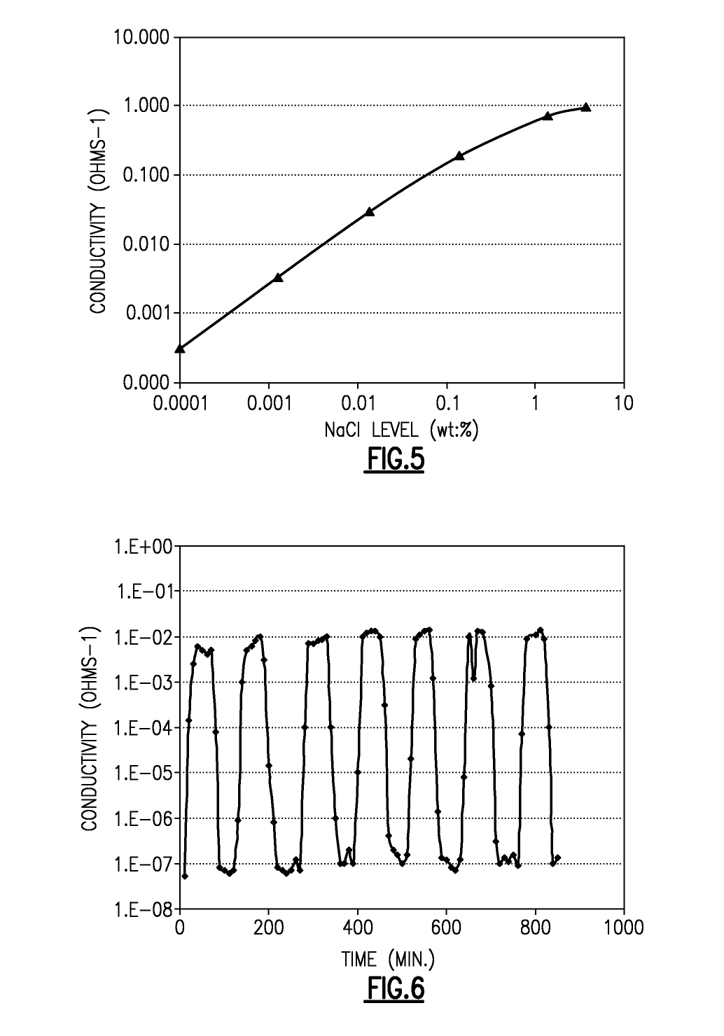

Referring to FIG. 6, this plot illustrates that the corrosion sensor 32 will effectively track a one hour wet/dry corrosion chamber cycle.

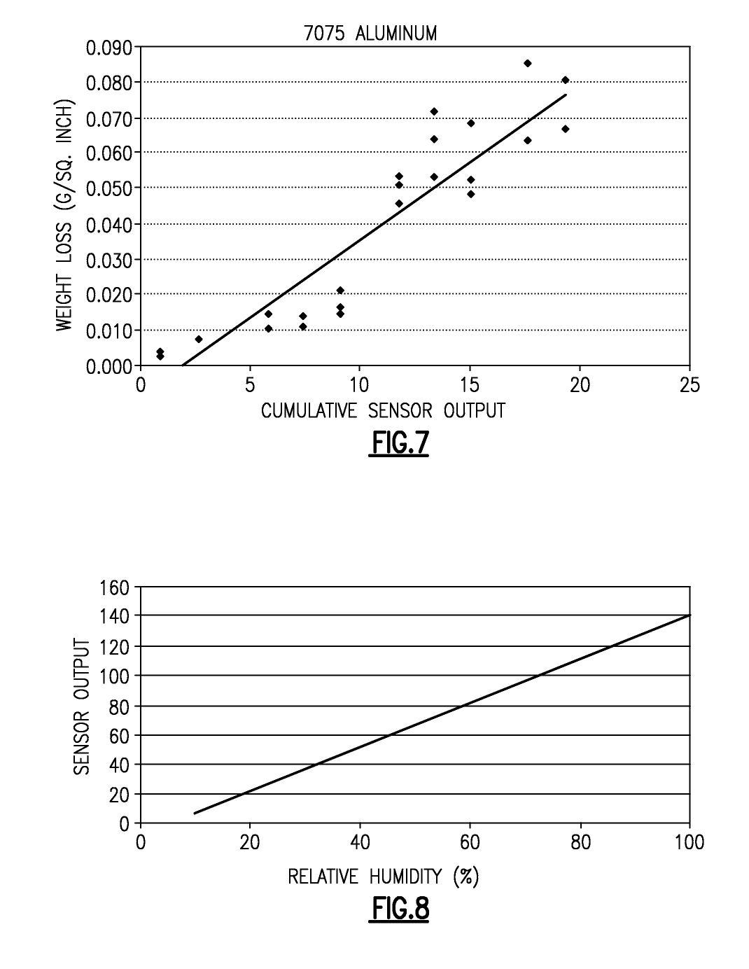

Referring to FIG. 7, this plot illustrates that the corrosion sensor 32 correlates to actual corrosion damage for an aircraft alloy.

Referring to Figure 8, this plot shows the measured output from the corrosion sensor 32 versus relative humidity level and illustrates that the corrosion sensor system 30 tracks the humidity response.

The corrosion sensor system 30 provides: superior durability as unlike most corrosion sensors, the corrosion sensor 32 is not consumed by the measurement process and is manufactured of corrosion resistant materials; high sensitivity as the corrosion sensor 32 will detect various solutions from thin condensed films of moisture such as humidity to concentrated acids such as spills; rapid response time through the electrical conductivity signal; superior immunity to contaminants through the noble metals and inert plastic materials; multi-functional analysis as the corrosion sensor 32 will detect local corrosion conditions, weather/humidity conditions, paint integrity, and filiform corrosion; and is cost effective since the corrosion sensor 32 may be fabricated via flex circuit technology.

It should be understood that relative positional terms such as “forward,” “aft,” “upper,” “lower,” “above,” “below,” and the like are with reference to the normal operational attitude of the vehicle and should not be considered otherwise limiting.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present invention.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the invention may be practiced other than as specifically described. For that reason the appended claims should be studied to determine true scope and content.

What is claimed is:

1. A corrosion sensor system comprising:
a substrate; and
a sensor array attached to said substrate, said sensor array includes at least two interlaced inert electrodes.

2. The system as recited in claim 1, wherein said substrate is manufactured of a polyimide material.

3. The system as recited in claim 1, wherein said sensor array includes at least two inert electrodes attached to an edge of said substrate.

4. The system as recited in claim 1, further comprising a data log unit in communication with said sensor array.

5. The system as recited in claim 4, wherein said data log unit is in communication with said sensor array through a pin connector which extends transverse to at least a portion of said sensor array.

6. The system as recited in claim 5, wherein said data log unit is mountable above a coating and said sensor array is mountable below said coating, said pin connector extends through said coating.

7. The system as recited in claim 4, wherein said data log unit communicates through a wireless communication system.

8. The system as recited in claim 1, further comprising a hydrophilic coating upon said substrate.

9. The system as recited in claim 1, wherein said at least two interlaced inert electrodes are manufactured of a noble metal.

10. The system as recited in claim 1, wherein said at least two interlaced inert electrodes are manufactured of a conductive polymer.

11. A method of corrosion detection comprising:
measuring electrical conductivity with a sensor array attached to a substrate, the sensor array including at least two interlaced inert electrodes.

12. A method as recited in claim 11, wherein measuring the electrolyte conductivity further comprises:
measuring an electrolyte conductivity;
measuring a temperature;
measuring a time of wetness; and
determining corrosion output data in response to the electrolyte conductivity, the time of wetness and the temperature.

13. A method as recited in claim 11, wherein measuring the electrolyte conductivity further comprises:
passing an alternating current (AC) through a solution between two noble metal electrodes; and
measuring a voltage drop.

14. A method as recited in claim 13, further comprising:
detecting relative humidity.

15. A method as recited in claim 13, further comprising:
detecting a discrete liquid contact.

16. A method as recited in claim 13, further comprising:
detecting a filiform corrosion.

17. A method as recited in claim 12, further comprising:
periodically storing the corrosion output data within a data log unit.

18. A method as recited in claim 12, further comprising:
biasing the electrolyte conductivity in response to a coating for a coating array located below a coating.
